(19) United States
(12) Patent Application Publication
(10) Pub. No.: US 2026/0060869 A1
(43) Pub. Date: Mar. 5, 2026

(54) DENTAL CHAIR PROVIDED WITH ORAL ISOLATOR

(71) Applicant: HOSPITAL OF STOMATOLOGY, GUANGZHOU MEDICAL UNIVERSITY, Guangzhou (CN)

(72) Inventors: Yunyan ZHANG, Guangzhou (CN); Leifei CHEN, Guangzhou (CN); Meiling ZOU, Guangzhou (CN); Xuguang GAO, Guangzhou (CN)

(21) Appl. No.: 19/309,809

(22) Filed: Aug. 26, 2025

(30) Foreign Application Priority Data
Aug. 30, 2024 (CN) 2024112109456

(51) Int. Cl. A61G 15/16; A61C 5/90; A61C 17/10; A61G 15/02

(52) U.S. Cl. CPC A61G 15/16; A61C 5/90; A61C 17/10; A61G 15/02

(57) ABSTRACT

A dental chair provided with an oral isolator, comprising: a dental chair body, an oral isolator, a tray, a tray bracket and a drainage tube; the oral isolator is configured to isolate an oral cavity from a trachea; the oral isolator comprises an isolator body, a sealing retaining ring and a T-shaped connector; and the isolator body comprises a hollow cylindrical tube bracket, a tongue plate, a polygonal sealing plate, a first upper isolation plate and a second upper isolation plate. Through the oral isolator, separation of waste contaminants and prevention of mutual interference during ventilation are achieved. The oral isolator is capable of conforming closely to the patient's oral cavity while maintaining a clear visual field in the treatment area, ensuring safety of the treatment process.

### CROSS-REFERENCE TO RELATED APPLICATIONS

This application claims priority to Chinese Patent Application No. 202411210945.6, filed on July Aug. 30, 2024, which is incorporated herein by reference in its entirety.

### TECHNICAL FIELD

The present disclosure relates to the field of dental chairs, and particularly relates to a dental chair provided with an oral isolator.

### BACKGROUND

Conventional dental chairs only feature height adjustment functionality. They cannot adjust pitch angles at different positions according to patient needs, resulting in patient discomfort during treatment. Furthermore, during dental treatment, waste contaminants, liquids, and other substances are generated. These may enter the patient's body along with respiratory airflow, causing patient discomfort and simultaneously interfering with the dentist's procedures, instruments or cotton balls falling into the trachea, causing serious complications and even death. Therefore, providing a dental chair featuring an oral isolation functionality and convenient adjustability is an urgent technical problem requiring resolution by those skilled in the art.

### SUMMARY

To address the above technical problems, the present disclosure provides a dental chair provided with an oral isolator, comprising: a dental chair body, an oral isolator, a tray, a tray bracket and a drainage tube;
the dental chair body comprises a backrest plate, a seat plate, a leg support plate, a lifting adjustment mechanism and a tilt adjustment mechanism; the lifting adjustment mechanism is disposed at a bottom of the seat plate and is configured to adjust a height of the dental chair body; and the tilt adjustment mechanism is disposed at a connection between the backrest plate and the seat plate, and at a connection between the seat plate and the leg support plate, and the tilt adjustment mechanism is configured to adjust a connection angle;
the tray bracket is disposed at a side portion of the dental chair body, the tray is disposed at a top of the tray bracket, and the oral isolator is placed on the tray; and the oral isolator is configured to isolate an oral cavity from a trachea.

Optionally, the oral isolator comprises: an isolator body, a sealing retaining ring and a T-shaped connector; and the isolator body comprises a hollow cylindrical tube bracket, a tongue plate, a polygonal sealing plate and a first upper isolation plate;
the hollow cylindrical tube bracket comprises a first lower tube, a second lower tube, a first middle tube, a second middle tube, a first upper tube, a second upper tube and an upper connecting tube; the first lower tube and the second lower tube are identical in structure and are disposed at a bottom portion of the hollow cylindrical tube bracket; the first middle tube and the second middle tube are identical in structure and are disposed at a middle portion of the hollow cylindrical tube bracket; the first upper tube and the second upper tube are identical in structure and are disposed at an upper portion of the hollow cylindrical tube bracket; the first lower tube is connected to the first middle tube, the first middle tube is connected to the first upper tube, the second lower tube is connected to the second middle tube, the second middle tube is connected to the second upper tube, and the upper connecting tube is connected between the first upper tube and the second upper tube; the T-shaped connector is connected between the first lower tube and the second lower tube; and the upper connecting tube is provided with a through-hole communicating with an outside;
an obtuse included angle is formed between each lower tube and the corresponding middle tube; an obtuse included angle is formed between each middle tube and the corresponding upper tube; an acute included angle is formed between the first lower tube and the second lower tube; and an acute included angle is formed between the first upper tube and the second upper tube;
the tongue plate is in a shape of a gradually rising arched protrusion, and the tongue plate is disposed between the first lower tube and the second lower tube; the first upper isolation plate is hermetically connected to a region enclosed by the first upper tube, the second upper tube and the upper connecting tube, and the first upper isolation plate extends to a top of each middle tube; and the polygonal sealing plate is hermetically connected to a region enclosed by the first upper isolation plate, each middle tube and the tongue plate.

Optionally, an elastic connecting bend tube is provided between the first lower tube and the first middle tube, between the first middle tube and the first upper tube, between the second lower tube and the second middle tube, between the second middle tube and the second upper tube, between the first lower tube and the T-shaped connector, and between the second lower tube and the T-shaped connector.

Optionally, each lower tube comprises an array of upper suction holes, an array of lower suction holes and an intermediate partition plate; the intermediate partition plate divides each lower tube into an upper space and a lower space, the upper suction holes communicate with the upper space, and the lower suction holes communicate with the lower space; and the upper suction holes are located on an upper side of the tongue plate, and the lower suction holes are located on a lower side of the tongue plate.

Optionally, the T-shaped connector is internally hollow and communicates with the drainage tube, and a bottom of the drainage tube is connected to a suction device.

Optionally, a second upper isolation plate is disposed on an upper side of the first upper isolation plate, the second upper isolation plate is identical in shape to the first upper isolation plate, a hollow interlayer is formed between the first upper isolation plate and the second upper isolation plate, and each upper tube is provided with a plurality of air holes communicating with the hollow interlayer.

Optionally, each middle tube is internally provided with a plurality of staggered blocking plates inclined downwardly.

Optionally, the sealing retaining ring is disposed at a rear portion of the isolator body, and the sealing retaining ring has a shape that matches a contour of a rear portion of the oral cavity.

Optionally, the hollow cylindrical tube bracket, the tongue plate, the polygonal sealing plate, the first upper isolation plate and the second upper isolation plate are all made of an elastic material.

Compared with the prior art, the present disclosure achieves the following technical effects:
1. The dental chair enables height adjustment and pitch angle adjustment at different positions, enhancing patient comfort during treatment.
2. The dental chair is equipped with the oral isolator. The oral isolator is capable of conforming closely to the patient's oral cavity. Through cooperation of the isolator body, the sealing retaining ring, and other structures, the oral isolator achieves isolation between the oral cavity and the trachea, separation of waste contaminants, prevention of mutual interference during ventilation, maintenance of a clear visual field in the treatment area, and ensured safety of the treatment process.
3. The intermediate partition plate in the inner portion of the isolator body is capable of preventing fluid communication between upper and lower sides of the tongue plate. This is capable of ensuring drainage of secretions at the lower side of the tongue plate while preventing contaminating the lower side of the tongue plate, thereby further enhancing safety.

### BRIEF DESCRIPTION OF THE DRAWINGS

FIG. 1 is a schematic structural view of a dental chair provided with an oral isolator according to an embodiment of the present disclosure.

FIG. 2 is a schematic structural view of the oral isolator in the dental chair provided with the oral isolator according to an embodiment of the present disclosure.

FIG. 3 is a schematic structural view of an isolator body in the dental chair provided with the oral isolator according to an embodiment of the present disclosure.

FIG. 4 is a schematic view showing the structure and connection of a lower tube in the dental chair provided with the oral isolator according to an embodiment of the present disclosure.

FIG. 5 is a schematic structural view of a middle tube, a first upper isolation plate, and a second upper isolation plate in the dental chair provided with the oral isolator according to an embodiment of the present disclosure.

FIG. 6 is a schematic connection structure view of a tongue plate, a polygonal sealing plate, and the first upper isolation plate in the dental chair provided with the oral isolator according to an embodiment of the present disclosure.

FIG. 7(a) is a front view of the oral isolator in the dental chair provided with the oral isolator according to an embodiment of the present disclosure.

FIG. 7(b) is a rear view of the oral isolator in the dental chair provided with the oral isolator according to an embodiment of the present disclosure.

FIG. 7(c) is a perspective view of the oral isolator in the dental chair provided with the oral isolator according to an embodiment of the present disclosure.

The realization of the objectives, functional features, and advantages of the present disclosure will be further described in conjunction with the embodiments and with reference to the accompanying drawings.

### DETAILED DESCRIPTION OF THE EMBODIMENTS

It should be understood that the specific embodiments described herein are merely illustrative of the present disclosure and are not intended to limit the present disclosure.

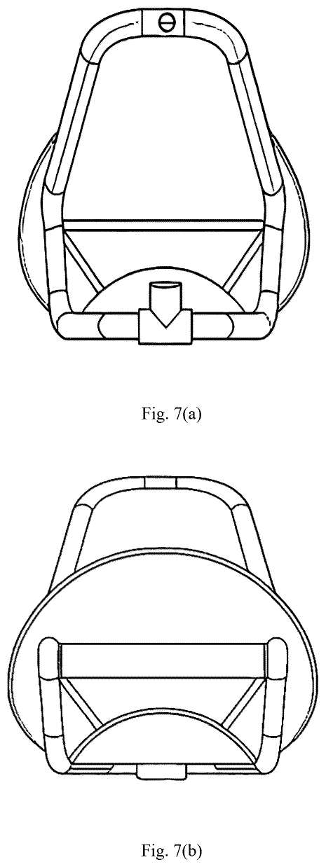

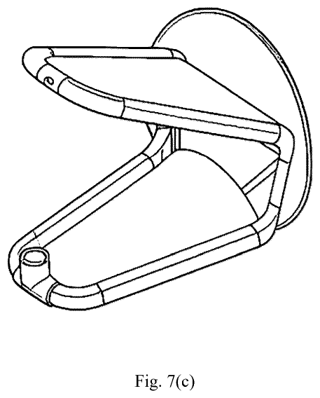

As shown in FIGS. 1-7, an embodiment of the present disclosure provides a dental chair provided with an oral isolator 2, comprising: a dental chair body 1, an oral isolator 2, a tray 3, a tray bracket 4 and a drainage tube 5.

As shown in FIG. 1, the dental chair body 1 comprises a backrest plate 11, a seat plate 13, a leg support plate 14, a lifting adjustment mechanism 15 and a tilt adjustment mechanism 12; the lifting adjustment mechanism 15 is disposed at a bottom of the seat plate 13 and is configured to adjust a height of the dental chair body 1; and the tilt adjustment mechanism 12 is disposed at a connection between the backrest plate 11 and the seat plate 13, and at a connection between the seat plate 13 and the leg support plate 14, and the tilt adjustment mechanism 12 is configured to adjust a connection angle.

The tray bracket 4 is disposed at a side portion of the dental chair body 1, the tray 3 is disposed at a top of the tray bracket 4, and the oral isolator 2 is placed on the tray 3; and the oral isolator 2 is configured to isolate an oral cavity from a trachea.

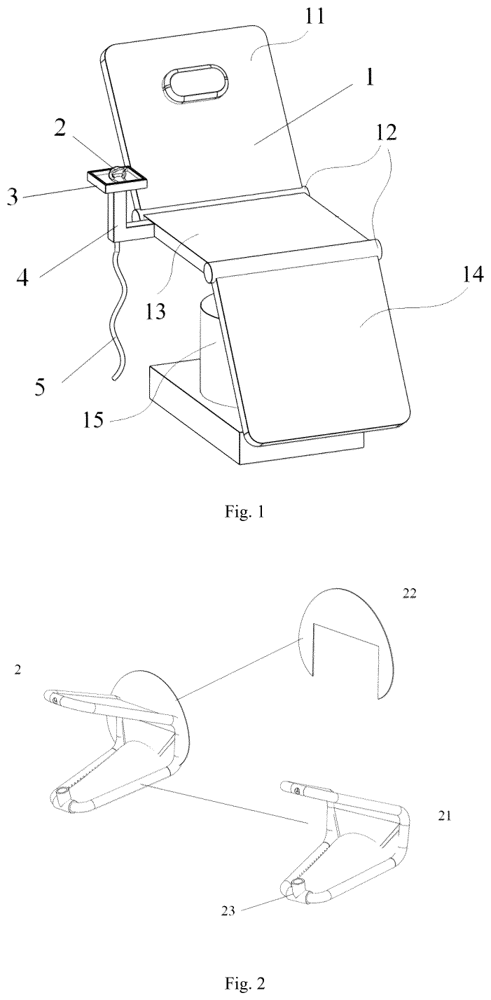

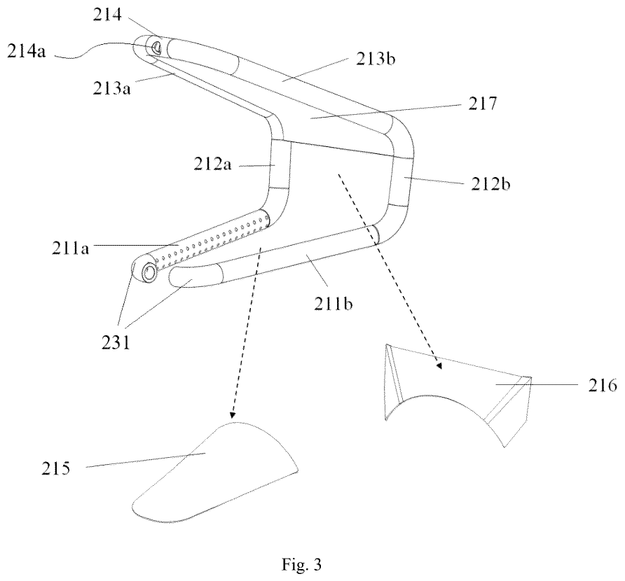

Optionally, as shown in FIGS. 2 and 3, the oral isolator 2 comprises: an isolator body 21, a sealing retaining ring 22 and a T-shaped connector 23; and the isolator body 21 comprises a hollow cylindrical tube bracket, a tongue plate 215, a polygonal sealing plate 216 and a first upper isolation plate 217.

As shown in FIG. 3, the hollow cylindrical tube bracket comprises a first lower tube 211a, a second lower tube 211b, a first middle tube 212a, a second middle tube 212b, a first upper tube 213a, a second upper tube 213b and an upper connecting tube 214; the first lower tube 211a and the second lower tube 211b are identical in structure and are disposed at a bottom portion of the hollow cylindrical tube bracket; the first middle tube 212a and the second middle tube 212b are identical in structure and are disposed at a middle portion of the hollow cylindrical tube bracket; the first upper tube 213a and the second upper tube 213b are identical in structure and are disposed at an upper portion of the hollow cylindrical tube bracket; the first lower tube 211a is connected to the first middle tube 212a, the first middle tube 212a is connected to the first upper tube 213a, the second lower tube 211b is connected to the second middle tube 212b, the second middle tube 212b is connected to the second upper tube 213b, and the upper connecting tube 214 is connected between the first upper tube 213a and the second upper tube 213b; the T-shaped connector 23 is connected between the first lower tube 211a and the second lower tube 211b; and the upper connecting tube 214 is provided with a through-hole 214a communicating with an outside.

As shown in FIG. 3, an obtuse included angle is formed between each lower tube (211a, 211b) and the corresponding middle tube (212a, 212b); an obtuse included angle is formed between each middle tube (212a, 212b) and the corresponding upper tube (213a, 213b); an acute included angle is formed between the first lower tube 211a and the second lower tube 211b; and an acute included angle is formed between the first upper tube 213a and the second upper tube 213b.

As shown in FIGS. 3, 4 and 6, the tongue plate 215 is in a shape of a gradually rising arched protrusion, and the tongue plate 215 is disposed between the first lower tube 211a and the second lower tube 211b; the first upper isolation plate 217 is hermetically connected to a region enclosed by the first upper tube 213a, the second upper tube 213b and the upper connecting tube 214, and the first upper isolation plate 217 extends to a top of each middle tube (212a, 212b); and the polygonal sealing plate 216 is hermetically connected to a region enclosed by the first upper isolation plate 217, each middle tube (212a, 212b) and the tongue plate 215.

Optionally, as shown in FIG. 3, a connecting bend tube 231 is provided between the first lower tube 211a and the first middle tube 212a, between the first middle tube 212a and the first upper tube 213a, between the second lower tube 211b and the second middle tube 212b, between the second middle tube 212b and the second upper tube 213b, between the first lower tube 211a and the T-shaped connector 23, and between the second lower tube 211b and the T-shaped connector 23.

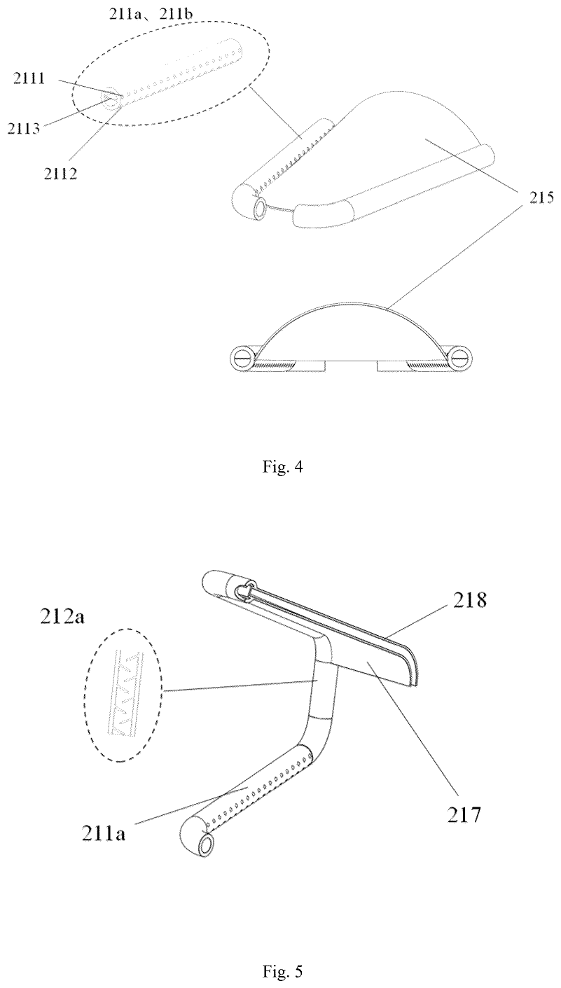

Optionally, as shown in FIG. 4, each lower tube (211a, 211b) comprises an array of upper suction holes 2111, an array of lower suction holes 2112 and an intermediate partition plate 2113; the intermediate partition plate 2113 divides each lower tube (211a, 211b) into an upper space and a lower space, the upper suction holes 2111 communicate with the upper space, and the lower suction holes 2112 communicate with the lower space; and the upper suction holes 2111 are located on an upper side of the tongue plate 215 (cooperating with a suction device to absorb filling materials, liquids, and other substances falling during dental treatment), and the lower suction holes 2112 are located on a lower side of the tongue plate 215 (cooperating with the suction device to absorb secretions at the lower portion).

Optionally, the T-shaped connector 23 is internally hollow and communicates with the drainage tube 5, and a bottom of the drainage tube 5 is connected to a suction device.

Optionally, as shown in FIG. 5, a second upper isolation plate 218 is disposed on an upper side of the first upper isolation plate 217, the second upper isolation plate 218 is identical in shape to the first upper isolation plate 217, a hollow interlayer is formed between the first upper isolation plate 217 and the second upper isolation plate 218, and each upper tube (213a, 213b) is provided with a plurality of air holes communicating with the hollow interlayer.

Optionally, each middle tube (212a, 212b) is internally provided with a plurality of staggered blocking plates inclined downwardly, thereby preventing backflow of substances in each lower tube (211a, 211b) during suction.

Optionally, the sealing retaining ring 22 is disposed at a rear portion of the isolator body 21, and the sealing retaining ring 22 has a shape that matches a contour of a rear portion of the oral cavity.

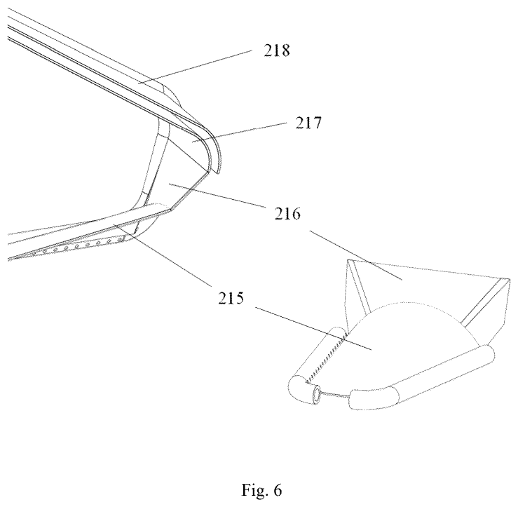

Optionally, as shown in FIG. 6, the hollow cylindrical tube bracket, the tongue plate 215, the polygonal sealing plate 216, the first upper isolation plate 217 and the second upper isolation plate 218 are all made of transparent elastic material such as rubber, plastic, or other materials.

Optionally, the lifting adjustment mechanism is a lifting cylinder.

Optionally, the tray bracket 4 is provided with a perforation. The drainage tube 5 is connected to the oral isolator 2 via the perforation.

Operational principle of the dental chair provided with the oral isolator: A patient sits on the dental chair body 1. The dental chair body 1 is adjusted to set the height and pitch angle. After adjustment, the oral isolator 2 is placed into the patient's oral cavity, where the isolator body 21 holds open the patient's oral cavity. Each lower tube (211a, 211b) is positioned at an inner side of lower teeth. Each upper tube (213a, 213b) is positioned at an inner side of upper teeth. The sealing retaining ring 22 is positioned at a rear side of the oral cavity. During dental treatment, fallen waste materials, liquids, and other substances are suctioned externally through the upper suction holes 2111 of each lower tube (211a, 211b). Tongue secretions are suctioned externally through the lower suction holes 2112 of each lower tube (211a, 211b).

The upper connecting tube 214 is configured to connect to an external gas supply device to increase gas supply flow. The upper connecting tube 214 is provided with a through-hole communicating with the outside. External gases pass through the through-hole and a plurality of air holes in each upper tube (213a, 213b) into a hollow interlayer between the isolation plates (217, 218), and ultimately are transmitted to the trachea. Exhaled gases are discharged through the air holes and the lower suction holes 2112 to the outside.

The configured structure of the oral isolator achieves isolation between the oral cavity and the trachea. The oral isolator is formed of soft, transparent materials. Separated collection structures and tracheal channels achieve waste separation and prevention of mutual interference during ventilation. The oral isolator is capable of conforming closely to the patient's oral cavity while maintaining a clear visual field in the treatment area, ensuring safety of the treatment process.

Finally, it should be noted that the above embodiments are provided merely to illustrate the technical solution of the present disclosure and not to limit it. Although the present disclosure has been described in detail with reference to preferred embodiments, those of ordinary skill in the art should understand that modifications or equivalent substitutions may be made to the technical solutions of the present disclosure without departing from the spirit and scope of the technical solutions of the present disclosure.

What is claimed is:

1. A dental chair provided with an oral isolator, comprising: a dental chair body, an oral isolator, a tray, a tray bracket and a drainage tube;
the dental chair body comprises a backrest plate, a seat plate, a leg support plate, a lifting adjustment mechanism and a tilt adjustment mechanism; the lifting adjustment mechanism is disposed at a bottom of the seat plate and is configured to adjust a height of the dental chair body; and the tilt adjustment mechanism is disposed at a connection between the backrest plate and the seat plate, and at a connection between the seat plate and the leg support plate, and the tilt adjustment mechanism is configured to adjust a connection angle;
the tray bracket is disposed at a side portion of the dental chair body, the tray is disposed at a top of the tray bracket, and the oral isolator is placed on the tray; and the oral isolator is configured to isolate an oral cavity from a trachea;
the oral isolator comprises: an isolator body, a sealing retaining ring and a T-shaped connector; and the isolator body comprises a hollow cylindrical tube bracket, a tongue plate, a polygonal sealing plate and a first upper isolation plate;
the hollow cylindrical tube bracket comprises a first lower tube, a second lower tube, a first middle tube, a second middle tube, a first upper tube, a second upper tube and an upper connecting tube; the first lower tube and the second lower tube are identical in structure and are disposed at a bottom portion of the hollow cylindrical tube bracket; the first middle tube and the second middle tube are identical in structure and are disposed at a middle portion of the hollow cylindrical tube bracket;
and the first upper tube and the second upper tube are identical in structure and are disposed at an upper portion of the hollow cylindrical tube bracket;
the first lower tube is connected to the first middle tube, the first middle tube is connected to the first upper tube, the second lower tube is connected to the second middle tube, the second middle tube is connected to the second upper tube, and the upper connecting tube is connected between the first upper tube and the second upper tube;
the T-shaped connector is connected between the first lower tube and the second lower tube; the upper connecting tube is provided with a through-hole communicating with an outside; an obtuse included angle is formed between each lower tube and the corresponding middle tube; an obtuse included angle is formed between each middle tube and the corresponding upper tube; an acute included angle is formed between the first lower tube and the second lower tube; and an acute included angle is formed between the first upper tube and the second upper tube; and
the tongue plate is in a shape of a gradually rising arched protrusion, and the tongue plate is disposed between the first lower tube and the second lower tube; the first upper isolation plate is hermetically connected to a region enclosed by the first upper tube, the second upper tube and the upper connecting tube, and the first upper isolation plate extends to a top of each middle tube; and the polygonal sealing plate is hermetically connected to a region enclosed by the first upper isolation plate, each middle tube and the tongue plate.

2. The dental chair according to claim 1, wherein an elastic connecting bend tube is provided between the first lower tube and the first middle tube, between the first middle tube and the first upper tube, between the second lower tube and the second middle tube, between the second middle tube and the second upper tube, between the first lower tube and the T-shaped connector, and between the second lower tube and the T-shaped connector.

3. The dental chair according to claim 2, wherein each lower tube comprises an array of upper suction holes, an array of lower suction holes and an intermediate partition plate; the intermediate partition plate divides each lower tube into an upper space and a lower space, the upper suction holes communicate with the upper space, and the lower suction holes communicate with the lower space; and the upper suction holes are located on an upper side of the tongue plate, and the lower suction holes are located on a lower side of the tongue plate.

4. The dental chair according to claim 3, wherein the T-shaped connector is internally hollow and communicates with the drainage tube, and a bottom of the drainage tube is connected to a suction device.

5. The dental chair according to claim 4, wherein a second upper isolation plate is disposed on an upper side of the first upper isolation plate, the second upper isolation plate is identical in shape to the first upper isolation plate, a hollow interlayer is formed between the first upper isolation plate and the second upper isolation plate, and each upper tube is provided with a plurality of air holes communicating with the hollow interlayer.

6. The dental chair according to claim 5, wherein each middle tube is internally provided with a plurality of staggered blocking plates inclined downwardly.

7. The dental chair according to claim 6, wherein the sealing retaining ring is disposed at a rear portion of the isolator body, and the sealing retaining ring has a shape that matches a contour of a rear portion of the oral cavity.

8. The dental chair according to claim 7, wherein the hollow cylindrical tube bracket, the tongue plate, the polygonal sealing plate, the first upper isolation plate and the second upper isolation plate are all made of an elastic material.
